(19) United States
(12) Patent Application Publication
(10) Pub. No.: US 2021/0006709 A1
(43) Pub. Date: Jan. 7, 2021

(54) CONTROL DEVICE, PHOTOGRAPHING DEVICE, CONTROL METHOD, AND PROGRAM

(71) Applicant: SZ DJI TECHNOLOGY CO., LTD., Shenzhen (CN)

(72) Inventors: Kenichi HONJO, Shenzhen (CN); Ming SHAO, Shenzhen (CN)

(21) Appl. No.: 17/027,303

(22) Filed: Sep. 21, 2020

Related U.S. Application Data
(63) Continuation of application No. PCT/CN2019/083530, filed on Apr. 19, 2019.

(30) Foreign Application Priority Data
Apr. 26, 2018 (JP) 2018-085851

(51) Int. Cl. H04N 5/232; G02B 7/09; G02B 7/36

(52) U.S. Cl. CPC H04N 5/23212; G02B 7/36; G02B 7/09

(57) ABSTRACT

A control device includes a processor and a storage medium. The storage medium stores a program that, when executed by the processor, causes the processor to obtain a plurality of images shot at different lens positions of a focus lens of a photographing device, determine a target lens position of the focus lens that satisfies a preset condition based on blur amounts of the plurality of images, and control the focus lens to move close to the target lens position when a current lens position of the focus lens is within a preset range including the target lens position or control the focus lens based on an operation input when the current lens position is outside the preset range.

### CROSS-REFERENCE TO RELATED APPLICATION

This application is a continuation of International Application No. PCT/CN2019/083530, filed Apr. 19, 2019, which claims priority to Japanese Application No. 2018-085851, filed Apr. 26, 2018, the entire contents of both of which are incorporated herein by reference.

### TECHNICAL FIELD

The present disclosure relates to a control device, a photographing device, a control method and a program.

### BACKGROUND

Patent Document 1 discloses an image processing device which uses multiple images with different blur degrees taken with different shooting parameters to calculate distance information of a shot object in the image.

Patent Document 1: Japanese Patent No. 5932476.

### SUMMARY

In accordance with the disclosure, there is provided a control device including a processor and a storage medium. The storage medium stores a program that, when executed by the processor, causes the processor to obtain a plurality of images shot at different lens positions of a focus lens of a photographing device, determine a target lens position of the focus lens that satisfies a preset condition based on blur amounts of the plurality of images, and control the focus lens to move close to the target lens position when a current lens position of the focus lens is within a preset range including the target lens position or control the focus lens based on an operation input when the current lens position is outside the preset range.

Also in accordance with the disclosure, there is provided a photographing device including an operation member configured to receive an operation input, a focus lens, an imaging device configured to capture an optical image formed by the focus lens, and a control device. The control device includes a processor and a storage medium. The storage medium stores a program that, when executed by the processor, causes the processor to obtain a plurality of images shot at different lens positions of a focus lens of a photographing device, determine a target lens position of the focus lens that satisfies a preset condition based on blur amounts of the plurality of images, and control the focus lens to move close to the target lens position when a current lens position of the focus lens is within a preset range including the target lens position or control the focus lens based on an operation input when the current lens position is outside the preset range.

Also in accordance with the disclosure, there is provided a control method including obtaining a plurality of images shot at different lens positions of a focus lens of a photographing device, determining a target lens position of the focus lens that satisfies a preset condition based on blur amounts of the plurality of images, and controlling the focus lens to move close to the target lens position when a current lens position of the focus lens is within a preset range including the target lens position or controlling the focus lens based on an operation input when the current lens position is outside the preset range.

Also in accordance with the disclosure, there is provided a non-transitory computer-readable storage medium storing a program that, when executed, causes a computer to obtain a plurality of images shot at different lens positions of a focus lens of a photographing device, determine a target lens position of the focus lens that satisfies a preset condition based on blur amounts of the plurality of images, and control the focus lens to move close to the target lens position when a current lens position of the focus lens is within a preset range including the target lens position or control the focus lens based on an operation input when the current lens position is outside the preset range.

### BRIEF DESCRIPTION OF THE DRAWINGS

FIG. 1 is a diagram showing functional blocks of a photographing device.

FIG. 2 is a perspective view of an operation ring.

FIG. 3 is a diagram showing a curve representing a relationship between a blur amount and a lens position according to an embodiment of the disclosure.

FIG. 4 is a diagram showing a process of calculating a distance to an object based on a blur amount according to an embodiment of the disclosure.

FIG. 5 is a diagram for explaining a relationship among an object position, a lens position, and a focal length.

FIG. 6 is a diagram for explaining a control of a lens position of a focus lens.

FIG. 7 is a diagram for explaining another control of a lens position of a focus lens.

FIG. 8 is a diagram for explaining another control of a lens position of a focus lens.

FIG. 9 is a diagram for explaining a relationship between a rotation position of an operation ring and a lens position of a focus lens.

FIG. 10 is a diagram for explaining another relationship between a rotation position of an operation ring and a lens position of a focus lens.

FIG. 11 is a diagram for explaining another relationship between a rotation position of an operation ring and a lens position of a focus lens.

FIG. 12 is a flowchart of a control process of a lens position of a focus lens according to an embodiment of the disclosure.

FIG. 13 is a flowchart of another control process of a lens position of a focus lens according to an embodiment of the disclosure.

FIG. 14 is a diagram of a hardware configuration according to an embodiment of the disclosure.

### REFERENCE NUMERALS

100—Photographing Device 102—Photographing Unit 110—Imaging Controller 112—Obtaining Circuit 113—Division Circuit 114—Determination Circuit 115—Receiving Circuit 116—Derivation Circuit 117—Setting Circuit 120—Image Sensor 130—Memory 140—Focus Controller 160—Display Circuit 162—Instruction Circuit 200—Lens Unit 210—Focus Lens 211—Zoom Lens 212, 213—Lens Driver 214, 215—Position Sensor 220—Lens Controller 221—Drive Controller 240—Memory 250—Operation Ring 253—Mode Switch 270—Encoder Ring 271—Light Reflector 272—Light Reflector 274—Rotation State Detector 1200—Computer 1210—Host Controller 1212—CPU 1214—RAM 1220—Input/Output Controller 1222—Communication Interface 1230—ROM

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

Various embodiments of the present disclosure are described with reference to flowcharts and block diagrams. A block may represent a stage of a process of performing operations or a “unit” of a device that performs operations. The specific stage and “unit” can be implemented by programmable circuits and/or processors. A dedicated circuit may include a digital and/or an analog circuit, or may include an integrated circuit (IC) and/or a discrete circuit. A programmable circuit may include a reconfigurable circuit. The reconfigurable circuit may include a circuit with a logic operation such as logic AND, logic OR, logic XOR, logic NAND, logic NOR, or other logic operations, a flip-flop, a register, a field programmable gate array (FPGA), a programmable logic array (PLA)), or other memory components.

The computer-readable medium may include any tangible device that can store instructions to be executed by a suitable device. As a result, the computer-readable medium with instructions stored is provided with a product including instructions that can be executed to create means for performing operations specified by the flowchart or the block diagram. The computer-readable medium may include electronic storage media, magnetic storage media, optical storage media, electromagnetic storage media, semiconductor storage media, or the like. As a more specific example of the computer-readable medium, it may include a floppy disk (registered trademark), a floppy disk, a hard disk, a random-access memory (RAM), a read-only memory (ROM), an erasable programmable read-only memory (EPROM or a flash memory), an electrically erasable programmable read-only memory (EEPROM), a static random access memory (SRAM), a compact disc read-only memory (CD-ROM), a digital versatile disc (DVD), a Blu-ray® disc, a memory stick, or an integrated circuit card, etc.

The computer-readable instructions may include any one of source code or object code described in any combination of one or more programming languages. The source code or object code can include a programming language such as assembly instructions, instruction set architecture (ISA) instructions, machine instructions, machine-related instructions, microcode, firmware instructions, status setting data, or object-oriented programming languages such as Smalltalk, JAVA (registered trademark), C++, etc., or “C” programming language or similar programming languages. The computer-readable instructions may be provided locally or via a wide area network (WAN) such as a local area network (LAN) or an internet to a processor or a programmable circuit of a general-purpose computer, a special-purpose computer, or other programmable data processing device. The processor or programmable circuit can execute computer-readable instructions to create means for performing the operations specified in the flowchart or block diagram. Examples of processors include computer processors, processing units, microprocessors, digital signal processors, controllers, microcontrollers, and so on.

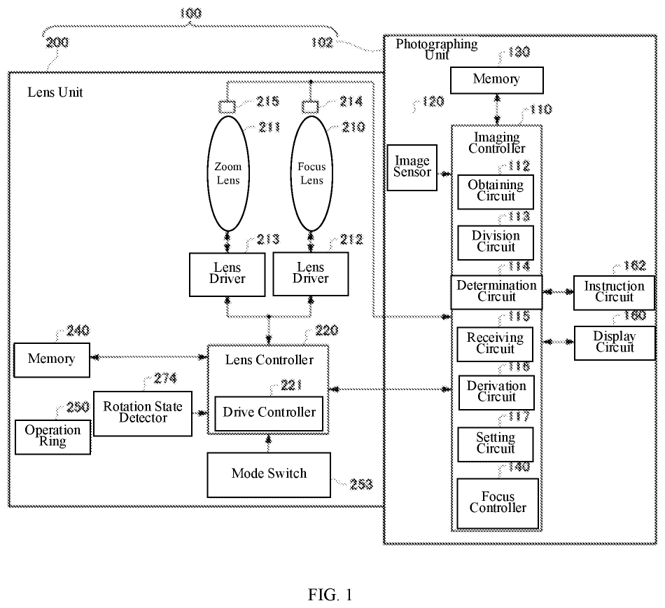

FIG. 1 is a diagram showing functional blocks of a photographing device 100 according to an embodiment. The photographing device 100 includes a photographing unit 102 and a lens unit 200. The lens unit 200 is an embodiment of a lens device. The photographing unit 102 includes an image sensor 120, an imaging controller 110, and a memory 130. The image sensor 120 may include CCD or CMOS. The image sensor 120 outputs image data of an optical image formed by a zoom lens 211 and a focus lens 210 to the imaging controller 110. The imaging controller 110 may be constituted by a microprocessor such as a CPU or an MPU, a microcontroller such as an MCU, or the like. The memory 130 may be a computer-readable medium, and may include at least one of an SRAM, a DRAM, an EPROM, an EEPROM, or a flash memory such as a USB memory. The memory 130 stores programs that the imaging controller 110 uses to control the image sensor 120 and the like. The memory 130 may be provided inside a housing of the photographing device 100. The memory 130 may be configured to be detachable from the housing of the photographing device 100.

The photographing unit 102 further includes an instruction circuit 162 and a display circuit 160. The instruction circuit 162 is a user interface that receives instructions to the photographing device 100 from a user. The display circuit 160 displays images captured by the image sensor 120, various setting information of the photographing device 100, or the like. The display circuit 160 may include a touch panel.

The lens unit 200 includes a focus lens 210, a zoom lens 211, a lens driver 212, a lens driver 213, and a lens controller 220. The focus lens 210 and the zoom lens 211 may include at least one lens. At least a part of or the entire focus lens 210 or zoom lens 211 are configured to be movable along an optical axis. The lens unit 200 may be an interchangeable lens that is provided to be detachable from the photographing unit 102. The lens driver 212 moves at least a part of or the entire focus lens 210 along the optical axis through a mechanism member such as a cam ring or a guide shaft. The lens driver 213 moves at least a part of or the entire zoom lens 211 along the optical axis through a mechanism member such as a cam ring or a guide shaft. The lens controller 220 drives at least one of the lens driver 212 or the lens driver 213 according to a lens control command from the photographing unit 102, and moves at least one of the focus lens 210 or the zoom lens 211 along the optical axis through a mechanism member to perform at least one of zooming action or focusing action. The lens control command may be a zoom control command or a focus control command.

The lens unit 200 further includes a memory 240, a position sensor 214, and a position sensor 215. The memory 240 stores control values of the focus lens 210 and the zoom lens 211 that are moved by the lens driver 212 and the lens driver 213. The memory 240 may include at least one of an SRAM, a DRAM, an EPROM, an EEPROM, or a flash memory such as a USB memory. The position sensor 214 may detect a lens position of the focus lens 210. The position sensor 214 may detect a current focus position. The position sensor 215 may detect a lens position of the zoom lens 211. The position sensor 215 may detect a current zoom position of the zoom lens 211.

The lens unit 200 further includes an operation ring 250, a rotation state detector 274, and a mode switch 253. The operation ring 250 is rotatably provided with respect to a lens barrel on the outside of the lens barrel that accommodates the focus lens 210 and the zoom lens 211. The operation ring 250 is an example of an operation member that receives an operation input from a user. The operation ring 250 is an example of the operation member manually operated by the user to adjust the position of the focus lens 210. The operation member is not limited to the operation ring 250, as long as it is an operable user interface. The operation member may also be another operation member such as a jog dial or a slide switch, which is capable of detecting an operation amount, an operation direction, and an operation speed. The concept of the user operating the operation ring 250 includes user operations. For example, operating the operation ring 250 by setting a mechanical device on the operation ring 250 and operating the mechanical device with a remote device also belongs to this concept.

The operation ring 250 may be not mechanically connected to the internal focus lens 210 included in the lens unit 200. The lens controller 220 relatively and electrically moves the focus lens 210 based on the operation of the operation ring 250. The rotation state detector 274 is a sensor that detects a rotation state of the operation ring 250 including at least one of a rotation amount, a rotation direction, or a rotation speed of the operation ring 250.

The mode switch 253 switches between a manual focus mode (MF mode) and an auto focus mode (AF mode). In the MF mode, a drive controller 221 controls the position of the focus lens 210 according to at least one of the rotation amount, the rotation direction, or the rotation speed of the operation ring 250. In the AF mode, the drive controller 221 controls the position of the focus lens 210 according to an instruction from the imaging controller 110.

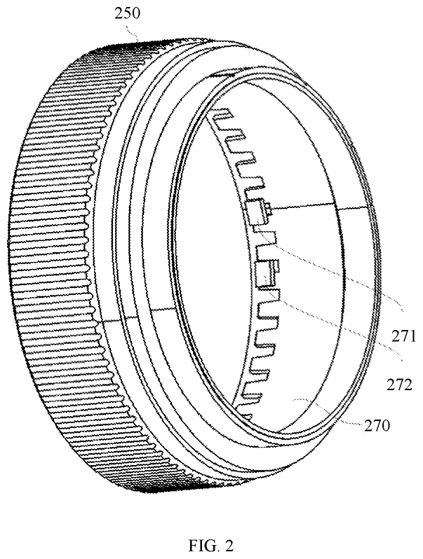

FIG. 2 is a perspective view of the operation ring 250 according to an embodiment. An encoder ring 270 and a pair of light reflectors 271 and 272 are provided at an inner surface of the operation ring 250. The pair of light reflectors 271 and 272 are examples of the rotation state detector 274. The encoder ring 270 is a comb-shaped reflection plate having reflection portions at equal intervals. The pair of light reflectors 271 and 272 receive the reflected light reflected by the encoder ring 270 among the light irradiated by themselves. Based on a combination of light receiving modes of the pair of light reflectors 271 and 272, the rotation amount and rotation direction of the operation ring 250 are determined.

In the AF mode, the photographing device 100 can control a position of the focus lens 210 by using a contrast AF mode, a phase difference AF mode, or an image plane phase difference AF mode, or by performing AF based on blur amounts of multiple images when the lens positions of the focus lens are different. The method of performing AF based on the blur amounts of multiple images is called Bokeh Detection Auto Focus (BDAF).

The BDAF mode is further described below. For example, a Gaussian function can be used to express the blur amount (Cost) of the image by following Formula (1). In Formula (1), x denotes a pixel position in a horizontal direction, σ denotes a standard deviation value, and C denotes the blur amount (Cost).

$$C ( x , σ ) = \frac{1}{\sqrt{2 π}} exp ( - \frac{{x}^{2}}{2 {σ}^{2}} ) \qquad Formula ( 1 )$$

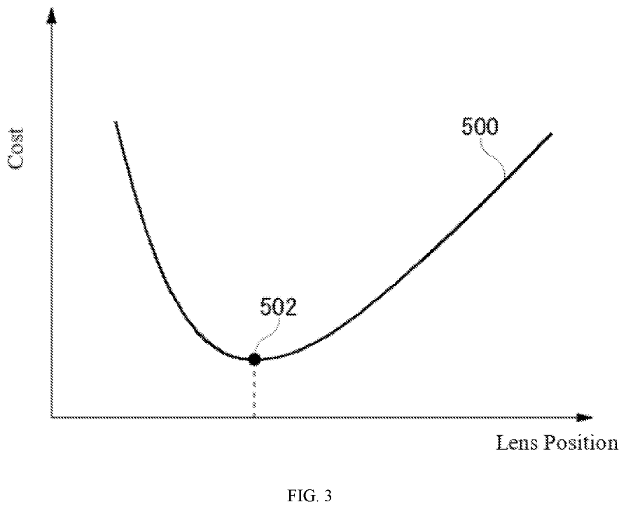

FIG. 3 shows an example of a curve representing Formula (1). By focusing the focus lens 210 to a lens position corresponding to a lowest point 502 of a curve 500, it is possible to focus on an object included in an image I.

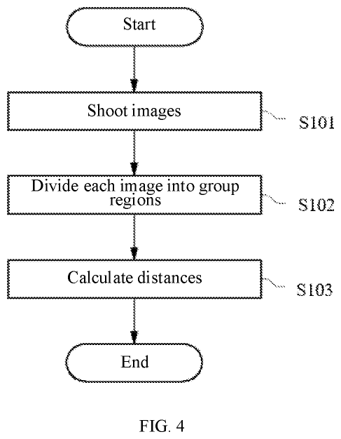

FIG. 4 is a flowchart of a process of calculating a distance between the photographing device 100 and an object by the BDAF mode according to an embodiment. As shown in FIG. 4, at S101, when a lens position of the focus lens 210 is at a first lens position, a first image I₁ is shot by the photographing device 100 and stored in the memory 130, and then the focus lens 210 is moved along an optical axis to place the lens position of the focus lens 210 at a second lens position and a second image I₂ is shot by the photographing device 100 and stored in the memory 130. This process is similar to the so-called hill-climbing AF, i.e., the focus lens 210 is moved along the optical axis without exceeding a focus point. The movement amount of the focus lens 210 may be, e.g., 10 μm.

At S102, the photographing device 100 divides image I₁ into a plurality of group regions. In some embodiments, a characteristic can be calculated for each pixel of image I₁, and a group of pixels with a similar characteristic can be used as a group region to divide image I₁ into a plurality of group regions. In some embodiments, the pixel group within a range set as an AF processing frame in image I₁ may be divided into a plurality of group regions. The photographing device 100 divides image I₂ into a plurality of group regions corresponding to the plurality of group regions of image I₁.

At S103, the photographing device 100 calculates the distance to an object included in each of the plurality of group regions based on the respective blur amounts of the plurality of group regions of image I₁ and the respective blur amounts of the plurality of group regions of image I₂.

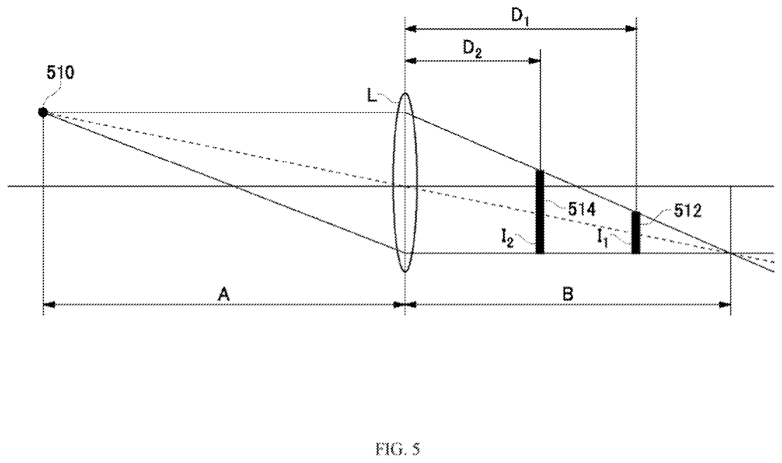

The distance calculation process is further described with reference to FIG. 5. A distance from a lens L (principal point) to an object 510 (object plane) is A, a distance from the lens L (principal point) to a position where the object 510 is imaged on an image plane is B, and a focal length is F. In this scenario, a relationship between distance A, distance B, and focal length F can be expressed by following Formula (2) according to a lens formula.

$$\frac{1}{A} + \frac{1}{B} = \frac{1}{F} \qquad Formula ( 2 )$$

The focal length F is determined by the lens position. Therefore, if distance B at which the object 510 is imaged on the image plane is determined, Formula (2) can be used to determine distance A from the lens L to the object 510.

As shown in FIG. 5, an imaging position of the object 510 can be calculated according to blur sizes (sizes of circles of confusion 512 and 514) of the object 510 projected on the image plane, thereby distance B can be determined and then distance A can be determined further. That is, the imaging position can be determined according to the size of the blur (blur amount) being in proportion to the image plane and a shooting position.

As shown in FIG. 5, a distance from image I₁, which is closer to the image plane, to the lens L is D₁, and a distance from image I₂, which is farther away from the image plane, to the lens L is D₂. Each image includes blurs, i.e., is blurry. A point spread function is denoted as PSF, and images at D₁ and D₂ are denoted as I_{d1} and I_{d2}. In this scenario, image I₁ can be expressed through a convolution operation as shown in Formula (3) below.

I₁=PSF*I_{d1} Formula (3)

In addition, a Fourier transform function for images I_{d1} and I_{d2} is denoted as f, and optical transfer functions obtained by the Fourier transform of the point spread functions PSF1 and PSF2 of images I_{d1} and I_{d2} are denoted as OTF₁ and OTF₂. A ratio can be obtained through following Formula (4).

$$\frac{{OTF}_{2} \cdot f}{{OTF}_{1} \cdot f} = \frac{{OTF}_{2}}{{OTF}_{1}} = C \qquad Formula ( 4 )$$

The value C shown in Formula (4) is a variation of the blur amounts of the images I_{d1} and I_{d2}, that is, the value C corresponds to a difference between the blur amount of image I_{d1} and the blur amount of image I_{d2}.

However, in the MF mode, when the photographing device 100 controls the lens position of the focus lens 210, due to the operation deviation of the operation ring 250, the focus accuracy may deviate. In the MF mode, a user confirms the blur degree (degree of blur) of the image displayed on the display circuit 160 by visual observation, and further operates the operation ring 250 to adjust the lens position of the focus lens 210. Therefore, in the MF mode, the focus accuracy may vary depending on the user's proficiency, etc.

Therefore, consistent with the disclosure, the photographing device 100 partially automates the control of the lens position of the focus lens 210 in the MF mode, thereby suppressing deviations in focus accuracy. As shown in FIG. 1, the imaging controller 110 includes an obtaining circuit 112, a determination circuit 114, a receiving circuit 115, a derivation circuit 116, a setting circuit 117, and a focus controller 140.

The obtaining circuit 112 obtains a plurality of images shot when the lens positions of the focus lens 210 are different from each other. When the drive controller 221 controls the lens position of the focus lens 210 based on an operation input from a user, the obtaining circuit 112 may obtain a plurality of images shot when the lens positions of the focus lens 210 are different. When the drive controller 221 controls the lens position of the focus lens 210 based on the operation input from the user, the obtaining circuit 112 may obtain a first image shot when the lens position of the focus lens 210 is at the first lens position and a second image shot when the lens position of the focus lens 210 is at the second lens position.

The determination unit 114 determines an ideal lens position of the focus lens 210 that satisfies a preset condition based on the blur amounts of a plurality of images. The ideal lens position is an example of the first lens position, also referred to as a “target lens position.” The ideal lens position may be a lens position of the focus lens 210 where a focus state of the focus lens 210 satisfies a preset condition. The ideal lens position may be a lens position of the focus lens 210 where a blur degree of an object to be focused satisfies a preset condition. The ideal lens position may be a lens position of the focus lens 210 where an ideal focus state can be obtained. The ideal lens position may be a lens position of the focus lens 210 where the image blur amount (Cost) is displayed as a minimum value. The determination circuit 114 may determine a lens position of the focus lens 210, where an object included in a preset focus area in the plurality of images is focused, as an ideal lens position. The receiving circuit 115 may receive a designation of the focus area from the user through the display circuit 160 or the instruction circuit 162.

A division circuit 113 divides the plurality of images obtained by the obtaining circuit 112 into a plurality of group regions according to a preset condition. The division circuit 113 may divide the first image and the second image obtained by the obtaining circuit 112 into a plurality of group regions according to the preset condition. The division circuit 113 may calculate a characteristic for each pixel of the first image, and use a group of pixels with a similar characteristic as a group region to divide the first image into a plurality of group regions. The division circuit 113 may divide the pixel group within a range set in the focus area in the first image into a plurality of group regions. The determination circuit 114 may determine an ideal lens position for each of the plurality of group regions based on the respective blur amounts of the plurality of group regions of the plurality of images.

In the AF mode, the focus controller 140 instructs the drive controller 221 to bring the lens position of the focus lens 210 closer to the ideal lens position. In the MF mode, when the lens position of the focus lens 210 is within a preset range including the ideal lens position, the focus controller 140 outputs a focus control command to the drive controller 221 so that the lens position of the focus lens 210 is close to the ideal lens position. When the lens position of the focus lens 210 is outside the preset range, the focus controller 140 causes the drive controller 221 to control the lens position of the focus lens 210 based on an operation input from the user. When the lens position of the focus lens 210 is outside the preset range, the focus controller 140 may not output a focus control command for controlling the lens position of the focus lens 210 to the drive controller 221. When the focus controller 140 controls the lens position of the focus lens 210 based on an operation input from the user, the lens position of the focus lens 210 falls within a preset range including the ideal lens position. If the lens position of the focus lens 210 falls within a preset range including the ideal lens position, the focus controller 140 may output a focus control command to the drive controller 221 to bring the lens position of the focus lens 210 close to the ideal lens position.

In the MF mode, the lens position of the focus lens 210 falls within a preset range including the ideal lens position. Further, the drive controller 221 controls the position of the focus lens 210 through the lens driver 212 according to the focus control command from the focus controller 140, so that the lens position of the focus lens 210 is close to the ideal lens position. The drive controller 221 may control the position of the focus lens 210 through the lens driver 212 according to the focus control command from the focus controller 140, so that the lens position of the focus lens 210 is consistent with the ideal lens position.

In the MF mode, the drive controller 221 can control the position of the focus lens 210 through the lens driver 212 according to a focus control command from the focus controller 140 even if the drive controller does not receive an operation input from the user. In the MF mode, if a focus control command from the focus controller 140 is received, the drive controller 221 can prioritize the focus control command from the focus controller 140 over the operation input from the user, and control the position of the focus lens 210 through the lens driver 212. In the MF mode, when the lens position of the focus lens 210 is outside the preset range, the drive controller 221 may control the lens position of the focus lens 210 based on at least one of the operation amount, the operation direction, or the operation speed of the operation ring 250.

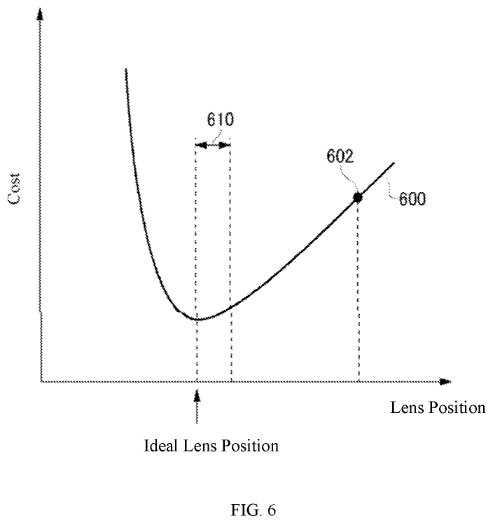

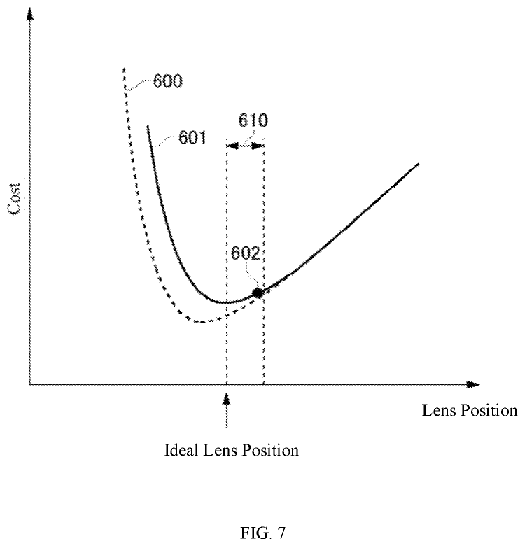

FIGS. 6, 7, and 8 show a curve 600 or a curve 601, which is an example of a curve derived from a blur amount of an image according to a Gaussian function. The point 602 on the curve 600 or the curve 601 exists at a position where the current lens position of the focus lens 210 corresponds to the blur amount (Cost) of the image. As the lens position of the focus lens 210 changes from a position farther away from the ideal lens position to a position closer to the ideal lens position, a reliability of the curve gradually increases. For example, as shown in FIG. 7, if the lens position of the focus lens 210 moves closer to the ideal lens position, the reliability of the curve increases and the curve changes from the curve 600 to the curve 601. This is because when the movement distance of the focus lens 210 is long, the curve can be derived from the blur amounts at multiple lens positions of the focus lens 210.

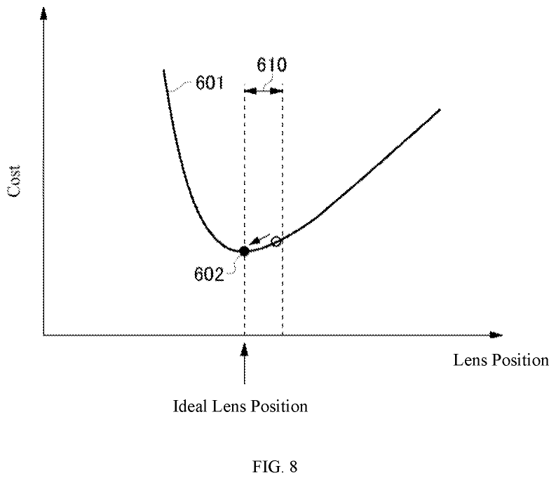

As shown in FIG. 6, if the current lens position (point 602) of the focus lens 210 is outside a preset range 610 that includes the ideal lens position, the drive controller 221 controls the lens position of the focus lens 210 based on the operation input from the user . Further, if the current lens position (point 602) of the focus lens 210 falls within the preset range as shown in FIG. 7, the drive controller 221 controls the lens position of the focus lens 210 through the lens driver 212 according to the focus control command from the focus controller 140 as shown in FIG. 8. Therefore, the lens position (point 602) of the focus lens 210 is automatically changed to the ideal lens position.

When there is a preset range including the current lens position of the focus lens 210 within a plurality of preset ranges each including a plurality of ideal lens positions of the plurality of group regions, the focus controller 140 may input a focus control command to the drive controller 221, so that the lens position of the focus lens 210 is close to the ideal lens position included in a preset lens range, which includes the current lens position of the focus lens 210. For example, there are multiple objects in an image, and their distances from the photographing device 100 are different. In this scenario, if the lens position of the focus lens 210 falls within a preset range of the ideal lens position of any one of the multiple objects due to the operation of the operation ring 250, the lens position of the focus lens 210 is automatically adjusted to the ideal lens position. The concept of bringing the lens position of the focus lens 210 close to the ideal lens position also includes bringing the lens position of the focus lens 210 to the ideal lens position.

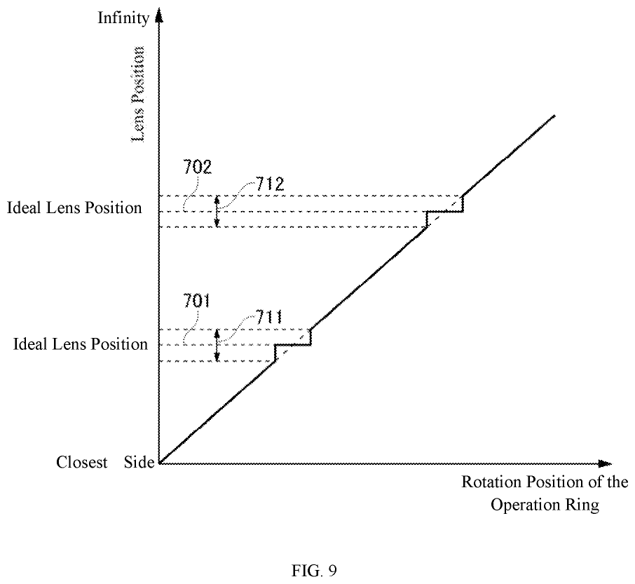

FIG. 9 shows an example of a relationship between a rotation position of the operation ring 250 and a lens position of the focus lens 210. For example, the division circuit 113 divides the image into a first group region and a second group region, and the determination circuit 114 determines an ideal lens position 701 for the first group region and determines an ideal lens position 702 for the second group region. The setting circuit 117 sets a preset range 711 for the ideal lens position 701 and sets a preset range 712 for the ideal lens position 702. In this scenario, if the lens position of the focus lens 210 falls within the preset range 711 due to the user operating the operation ring 250, the drive controller 221 automatically changes the lens position of the focus lens 210 to the ideal lens position 701 according to the focus control command from the focus controller 140. Further, if the lens position of the focus lens 210 falls within the preset range 712, the drive controller 221 automatically changes the lens position of the focus lens 210 to the ideal lens position 702 according to the focus control command from the focus controller 140.

The derivation circuit 116 derives a reliability of the ideal lens position. The derivation circuit 116 can derive the reliability of the ideal lens position based on the blur amounts of a plurality of images. The derivation circuit 116 may derive the reliability so that the reliability of the ideal lens position becomes higher when the blur amounts of the plurality of images are smaller. The derivation circuit 116 may derive the reliability of the ideal lens position based on a difference between the ideal lens position and the lens position of the focus lens 210. The derivation circuit 116 can derive the reliability so that the reliability of the ideal lens position is higher when the difference between the ideal lens position and the lens position of the focus lens 210 is smaller. The derivation circuit 116 may derive the reliability of the ideal lens position based on a number of images used by the determination circuit 114 to determine the ideal lens position. The derivation circuit 116 can derive the reliability so that the reliability of the ideal lens position is higher when the number of images used by the determination circuit 114 to determine the ideal lens position is greater. The setting circuit 117 may set the preset range based on the reliability of the ideal lens position derived by the derivation circuit 116 for determining whether to make the lens position of the focus lens 210 close to the ideal lens position in the MF mode. The setting circuit 117 may set the preset range so that the preset range is larger when the reliability of the ideal lens position derived by the derivation circuit 116 is higher.

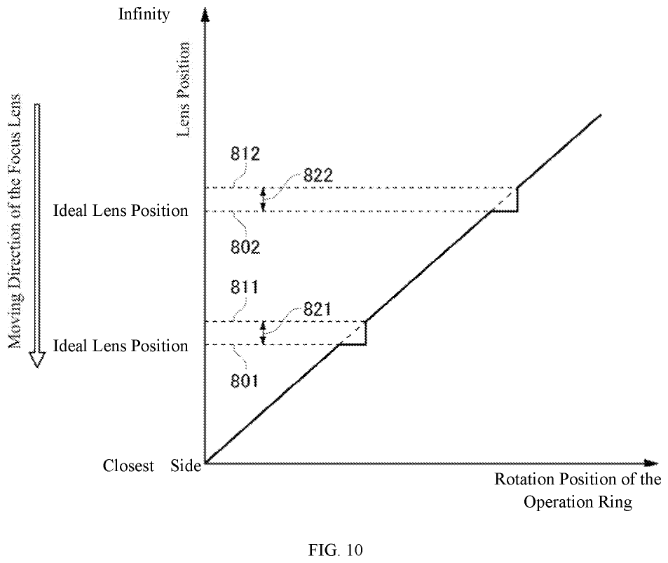

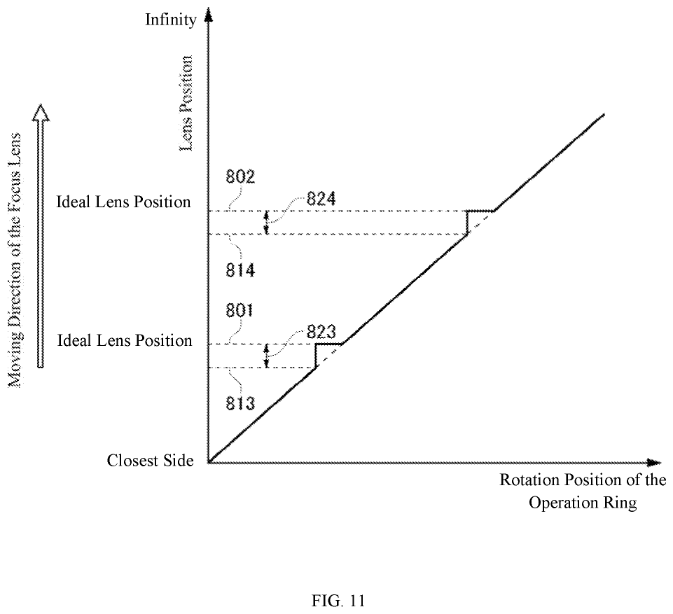

When the focus lens 210 is moved from an infinity side to a closest side based on an operation input, and when the focus lens 210 is moved from the closest side to the infinity side based on an operation input, the setting circuit 117 may set different preset ranges. As shown in FIG. 10, when the focus lens 210 is moved from the infinity side to the closest side, the setting circuit 117 may set ranges from an ideal lens position 801 and an ideal lens position 802 to a lens position 811 and a lens position 812 as a preset range 821 and a preset range 822, respectively. The lens position 811 and the lens position 812 are located at the infinity side with a preset value. As shown in FIG. 11, when the focus lens 210 is moved from the closest side to the infinity side, the setting circuit 117 may set ranges from the ideal lens position 801 and the ideal lens position 802 to a lens position 813 and a lens position 814 as a preset range 823 and a preset range 824 respectively. The lens position 813 and the lens position 814 are located at the closest side with a preset value.

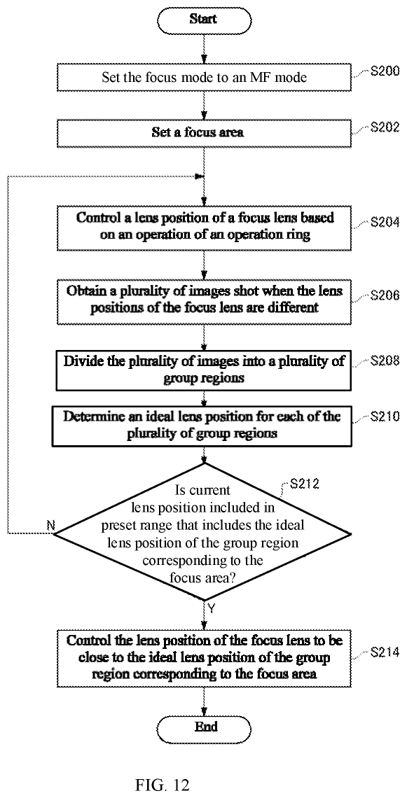

FIG. 12 is a flowchart of a control process of the lens position of the focus lens 210 in a manual focus mode according to an embodiment.

At S200, the mode switch 253 sets the focus mode to an MF mode. At S202, the receiving circuit 115 receives an area to be focused on from the user through the display circuit 160 and sets the received area as a focus area. At S204, the lens controller 220 controls the lens position of the focus lens 210 based on the user's operation of the operation ring 250. For example, the lens controller 220 may move the focus lens 210 by a movement amount corresponding to the operation amount of the operation ring 250 in a movement direction corresponding to the operation direction of the operation ring 250. During the movement of the focus lens 210 according to the operation of the operation ring 250, the obtaining circuit 112 obtains a plurality of images shot when the lens positions of the focus lens 210 are different (S206). The obtaining circuit 112 may obtain at least two images shot when the lens positions of the focus lens 210 are different from each other.

At S208, the division circuit 113 divides the plurality of images into a plurality of group regions according to a preset condition. At S210, the determination circuit 114 derives a blur amount for each of the plurality of group regions, and determines an ideal lens position for each of the plurality of group regions based on the respective blur amount of the plurality of group regions. At S212, the focus controller 140 determines whether the current lens position of the focus lens 210 is included in a preset range that includes the ideal lens position of the group region corresponding to the focus area. For example, the focus controller 140 may select a group region overlapping with the focus area as the group region corresponding to the focus area. When there are a plurality of group regions overlapping with the focus area, the focus controller 140 may select a group region, in which an object such as a face included in the focus area exists, from these group regions as the group region corresponding to the focus area.

When the current lens position of the focus lens 210 is not included in the preset range, the lens controller 220 continues to control the lens position of the focus lens 210 based on the user's operation of the operation ring 250. Further, when the current lens position of the focus lens 210 is included in the preset range, the focus controller 140 outputs a focus control command for controlling the lens position of the focus lens 210 to the lens controller 220, so that the lens position of the focus lens 210 is close to the ideal lens position. The lens controller 220 receives the focus control command from the focus controller 140 and controls the lens position of the focus lens 210 so that the lens position of the focus lens 210 is close to the ideal lens position (S214).

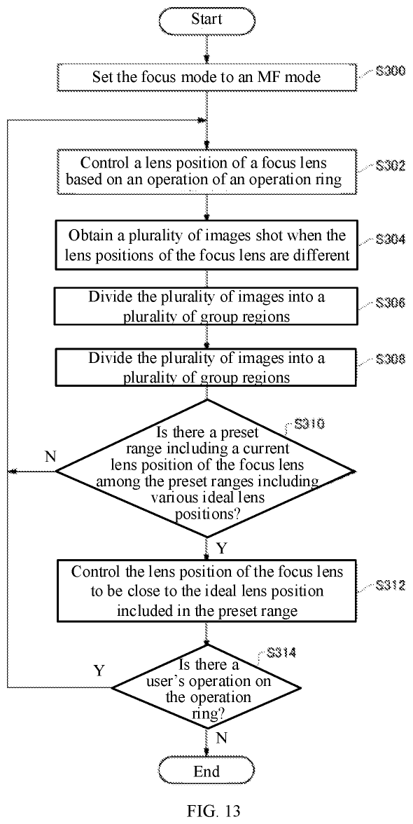

FIG. 13 is a flowchart of another control process of the lens position of the focus lens 210 in a manual focus mode according to an embodiment. The flowchart shown in FIG. 13 is different from the flowchart shown in FIG. 12 in that the focus area is not set.

At S300, the mode switch 253 sets the focus mode to an MF mode. At S302, the lens controller 220 controls the lens position of the focus lens 210 based on the user's operation of the operation ring 250. At S304, when the focus lens 210 is moved according to the operation of the operation ring 250, the obtaining circuit 112 obtains a plurality of images shot when the lens positions of the focus lens 210 are different. At S306, the division circuit 113 divides the plurality of images into a plurality of group regions according to a preset condition. At S308, the determination circuit 114 derives a blur amount for each of the plurality of group regions and determines an ideal lens position for each of the plurality of group regions based on the respective blur amount of the plurality of group regions. At S310, the focus controller 140 determines whether there is a preset range including the current lens position of the focus lens 210 among the preset ranges including various ideal lens positions.

When there is no preset range including the current lens position of the focus lens 210, the lens controller 220 continues to control the lens position of the focus lens 210 based on the user's operation of the operation ring 250. Further, when there is a preset range including the current lens position of the focus lens 210, the focus controller 140 outputs a focus control command for controlling the lens position of the focus lens 210 to the lens controller 220, so that the lens position of the focus lens 210 is close to the ideal lens position, which is included in the preset range. The lens controller 220 receives the focus control command from the focus controller 140 and controls the lens position of the focus lens 210 so that the lens position of the focus lens 210 is close to the ideal lens position included in the preset range (S312). At S314, the lens controller 220 continues to determine whether there is a user's operation on the operation ring 250. If there is an operation, the lens controller 220 returns to the process of S302 to continue the operation.

According to the embodiments, during the movement of the focus lens 210 in the MF mode, the ideal lens position is derived through the BDAF method. Moreover, if the lens position of the focus lens 210 falls within the preset range of the ideal lens position, the lens position of the focus lens 210 automatically approaches the ideal lens position. As a result, in the MF mode, a deviation in focus accuracy due to a deviation in the operation of the operation ring 250 can be suppressed. In the MF mode, when the user confirms the blur degree of the image displayed on the display circuit 160 by visual observation and further operates the operation ring 250 to adjust the lens position of the focus lens 210, a deviation in focus accuracy due to a user's proficiency can be suppressed. In the MF mode, the lens position of the focus lens 210 is automatically fine-adjusted to a lens position in a focused state, so that a deviation in focus accuracy due to a slight operation difference of the operation ring 250 by the user can be prevented.

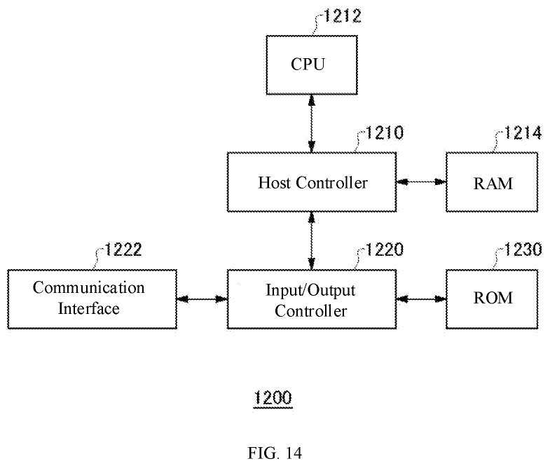

FIG. 14 shows an example of a computer 1200 that may fully or partially embody the present disclosure. The program installed on the computer 1200 can make the computer 1200 function as an operation associated with a device according to the embodiments of the present disclosure or one or more “units” of the device. In some embodiments, the program can cause the computer 1200 to perform the operation or the one or more “units.” The program enables the computer 1200 to execute a process or stages of the process consistent with embodiments of the present disclosure. The program can be executed by a CPU 1212 to make the computer 1200 execute specific operations associated with some or all of the blocks in the flowcharts or block diagrams described in this disclosure. That is, the program, when executed by the CPU 1212, can cause the computer 1200 (or more specifically the CPU 1212) to perform a method consistent with the disclosure, such as one of the above-described example methods.

The computer 1200 of this disclosure includes the CPU 1212 and a RAM 1214, which are connected to each other through a host controller 1210. The computer 1200 further includes a communication interface 1222, an input/output unit, which is connected to the host controller 1210 through an input/output controller 1220. The computer 1200 also includes a ROM 1230. The CPU 1212 operates in accordance with programs stored in the ROM 1230 and RAM 1214 to control each unit.

The communication interface 1222 communicates with other electronic devices through a network. A hard disk drive can store programs and data used by the CPU 1212 of the computer 1200. The ROM 1230 stores a bootloader executed by the computer 1200 during operation, and/or a program dependent on the hardware of the computer 1200. The program is provided through a computer-readable medium such as a CR-ROM, a USB memory, or an IC card, or a network. The program is installed in the RAM 1214 or the ROM 1230, which are examples of computer-readable medium, and is executed by the CPU 1212. The information processing described in the programs is read by the computer 1200 and causes cooperation between the program and the various types of hardware resources described above. The device or method may be constituted by realizing the operation or processing of information with the use of the computer 1200.

For example, when a communication is performed between the computer 1200 and an external device, the CPU 1212 can execute a communication program loaded in the RAM 1214, and based on the processing described in the communication program, instruct the communication interface 1222 to perform communication processing. Under the control of the CPU 1212, the communication interface 1222 reads transmission data stored in a transmission buffer provided in a recording medium such as the RAM 1214 or a USB memory, and transmits the read transmission data to a network or writes received data received from the network in a receiving buffer provided in a recording medium.

In addition, the CPU 1212 can make the RAM 1214 read all or necessary parts of files or databases stored in an external recording medium such as a USB memory, and perform various types of processing on the data on the RAM 1214. Then, the CPU 1212 can write the processed data back to the external recording medium.

Various types of information such as various types of programs, data, tables, and databases can be stored in the recording medium, and the information can be processed. For the data read from the RAM 1214, the CPU 1212 can execute various types of operations, information processing, conditional determination, conditional transfer, unconditional transfer, or information retrieval/replacement specified by the instruction sequence of the program described in the disclosure, and write the result back to the RAM 1214. In addition, the CPU 1212 can retrieve information in files, databases, or the like in the recording medium. For example, when a plurality of entries having attribute values of first attributes respectively associated with attribute values of second attributes are stored in the recording medium, the CPU 1212 may retrieve an entry that matches the condition that specifies the attribute value of the first attribute from the plurality of entries and read the attribute value of the second attribute stored in the entry to obtain the attribute value of the second attribute associated with the first attribute meeting a preset condition.

The programs or software modules described above may be stored at the computer 1200 or at a computer-readable storage medium near the computer 1200. In addition, a recording medium such as a hard disk or a RAM provided in a server system connected to a dedicated communication network or the internet can be used as a computer-readable storage medium to provide the program to the computer 1200 through the network.

The execution order of the actions, sequences, steps, and stages of the devices, systems, programs, and methods shown in the claims, specification, and drawings of the disclosure, can be implemented in any order as long as there is no special indication such as “before,” “in advance,” etc., and the output of the previous processing is not used in the subsequent processing. Regarding the operation procedures in the claims, the specification, and the drawings of the disclosure, the description is made using “first,” “next,” etc. for convenience, but it does not mean that the operations must be implemented in this order.

The present disclosure has been described above using embodiments, but the technical scope of the present disclosure is not limited to the scope described in the above embodiments. It is obvious to those skilled in the art that various changes or improvements can be made to the above-described embodiments. All such changes or improvements can be included in the scope of the present disclosure.

What is claimed is:

1. A control device comprising:
a processor; and
a storage medium storing a program that, when executed by the processor, causes the processor to:
obtain a plurality of images shot at different lens positions of a focus lens of a photographing device;
determine a target lens position of the focus lens that satisfies a preset condition based on blur amounts of the plurality of images; and
control the focus lens:
to move close to the target lens position in response to a current lens position of the focus lens being within a preset range including the target lens position; or
based on an operation input in response to the current lens position being outside the preset range.

2. The control device of claim 1, wherein the plurality of images are shot while the focus lens is controlled to move according to the operation input.

3. The control device of claim 1, wherein the program further causes the processor to move close to the target lens position in response to the current lens position moving into the preset range while the focus lens is controlled to move according to the operation input.

4. The control device of claim 1, wherein the program further causes the processor to control the current lens position of the focus lens based on the operation input in response to the current lens position being outside the preset range, the operation input includes a control of at least one of an operation amount, an operation direction, or an operation speed of an operation member.

5. The control device of claim 1, wherein the program further causes the processor to determine a lens position of the focus lens, at which an object included in a focus area in the plurality of images is focused, as the target lens position.

6. The control device of claim 5, wherein the program further causes the processor to receive a designation of the focus area.

7. The control device of claim 1, wherein the program further causes the processor to:
divide each of the plurality of images into a plurality of group regions according to a preset condition;
determine a corresponding target lens position for each of the plurality of group regions based on respective blur amounts of the plurality of group regions of the plurality of images, each corresponding target lens position being within one of a plurality of preset ranges; and
in response to the current lens position being within one of the plurality of preset ranges, control the focus lens to move close to the corresponding target lens position within the one of the plurality of preset ranges.

8. The control device of claim 1, wherein the program further causes the processor to set the preset range based on a reliability of the target lens position.

9. The control device of claim 1, wherein the program further causes the processor to set the preset range based on an operation input, the preset range set in response to the operation input to move the focus lens from an infinity side to a closest side being different from the preset range set in response to the operation input to move the focus lens from the closest side to the infinity side.

10. A photographing device comprising:
an operation member configured to receive an operation input;
a focus lens;
an imaging device configured to capture an optical image formed by the focus lens; and
a control device including:
a processor; and
a storage medium storing a program that, when executed by the processor, causes the processor to:
obtain a plurality of images shot at different lens positions of the focus lens;
determine a target lens position of the focus lens that satisfies a preset condition based on blur amounts of the plurality of images; and
control the focus lens:
to move close to the target lens position in response to a current lens position of the focus lens being within a preset range including the target lens position; or
based on an operation input in response to the current lens position being outside the preset range.

11. The photographing device of claim 10, further comprising:
a lens barrel accommodating the focus lens;
wherein the operation member includes an operation ring rotatably provided at an outside of the lens barrel.

12. The photographing device of claim 10, wherein the plurality of images are shot while the focus lens is controlled to move according to the operation input.

13. The photographing device of claim 10, wherein the program further causes the processor to move close to the target lens position in response to the current lens position moving into the preset range while the focus lens is controlled to move according to the operation input.

14. The photographing device of claim 10, wherein the program further causes the processor to control the current lens position of the focus lens based on the operation input in response to the current lens position being outside the preset range, the operation input includes a control of at least one of an operation amount, an operation direction, or an operation speed of an operation member.

15. The photographing device of claim 10, wherein the program further causes the processor to determine a lens position of the focus lens, at which an object included in a focus area in the plurality of images is focused, as the target lens position.

16. The photographing device of claim 10, wherein the program further causes the processor to:
divide each of the plurality of images into a plurality of group regions according to a preset condition;
determine a corresponding target lens position for each of the plurality of group regions based on respective blur amounts of the plurality of group regions of the plurality of images, each corresponding target lens position being within one of a plurality of preset ranges; and
in response to the current lens position being within one of the plurality of preset ranges, control the focus lens to move close to the corresponding target lens position within the one of the plurality of preset ranges.

17. The photographing device of claim 10, wherein the program further causes the processor to set the preset range based on a reliability of the target lens position.

18. The photographing device of claim 10, wherein the program further causes the processor to set the preset range based on an operation input, the preset range set in response to the operation input to move the focus lens from an infinity side to a closest side being different from the preset range set in response to the operation input to move the focus lens from the closest side to the infinity side.

19. A control method comprising:
obtaining a plurality of images shot at different lens positions of a focus lens of a photographing device;
determining a target lens position of the focus lens that satisfies a preset condition based on blur amounts of the plurality of images; and
controlling the focus lens:
to move close to the target lens position in response to a current lens position of the focus lens being within a preset range including the target lens position; or
based on an operation input in response to the current lens position being outside the preset range.

20. A non-transitory computer-readable storage medium storing a program that, when executed, cause a computer to perform the method of claim 19.
